(19) United States
(12) Patent Application Publication
(10) Pub. No.: US 2007/0203784 A1
(43) Pub. Date: Aug. 30, 2007

(54) Method of analyzing email content of registered users of a website and present these users with an offer

(76) Inventors: Arthur M. Keller, Palo Alto, CA (US); Sanjai Tiwari, Palo Alto, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/788,059

(22) Filed: Apr. 18, 2007

Related U.S. Application Data
(63) Continuation of application No. 09/365,586, filed on Jul. 30, 1999.
(60) Provisional application No. 60/115,244, filed on Jan. 7, 1999.

(51) Int. Cl. G06F 17/30

(52) U.S. Cl. 705/10

(57) ABSTRACT

The invention is a method for analyzing content of email messages of registered users of an electronic commerce website and presenting these users with an offer (e.g., a digital coupon, a sale offer, or an advertisement) relevant to the analyzed email content.

### CROSS-REFERENCE TO RELATED APPLICATIONS

This application is a Continuation Application of U.S. patent application with Ser. No. 09/365586 filed Jul. 30, 1999, which claims the benefit from U.S. Provisional Patent Application 60/115,244 filed Jan. 7, 1999.

### FIELD OF THE INVENTION

The present invention relates to the field of electronic commerce. In particular the present invention discloses an arrangement and methods for capturing and using Internet sales information after a transaction has occurred.

### BACKGROUND

The Internet is a global interconnection of computer networks that share a common set of protocols. Most computers on the global Internet use the Transport Control Protocol layer and the Internet Protocol layer commonly referred to as TCP/IP. By sharing a set of nonproprietary well-defined communication protocols, the Internet allows almost any computer system to communicate with any other computer system.

The Internet has existed in some form since 1969. It was used mainly by scientists and engineers until relatively recently. In the late 1980's and early nineties when personal computer systems became powerful enough to handle networking, a wider audience of users began using the Internet. Initially, most users used the Internet for file transfer, discussion groups, and email using the file transfer protocol (FTP), the network news protocol (NNTP), and the simple mail transport protocol (SMTP), respectively.

One particular transport protocol known as the hypertext transport protocol (HTTP) was created for sharing hypertext markup language (HTML) documents. The HTTP and HTML enabled the creation of simple-to-use but media rich documents that could easily be “browsed”. By linking together HTML documents located on various servers throughout the world using embedded hyperlinks, a “World Wide Web” (WWW) of interconnected hypertext documents was created. Due to the simple, yet powerful nature of HTML and HTTP, the World Wide Web (WWW) portion of the Internet has grown into the most popular form of Internet communication.

The WWW quickly became a new mass media system for information distribution. With the help of advertising support, thousands of news and information web sites have been created.

The HTML and HTTP standards have been amended to handle two-way communication. Specifically, a user can be presented with a “form” that can be filled-in and send back to a server. Using processing system often known as Common Gateway Interface (CGI) scripts, a server can obtain information from a person browsing its pages. These interactive techniques have been used to create commercial WWW sites that can perform financial transactions. Thus, the Internet has become the new frontier of commercial commerce.

Internet commerce is growing at an exponential rate. New methods of handling the all the information generated by Internet based commercial transactions would be desirable.

### SUMMARY OF THE INVENTION

The invention is a method for gathering detailed information about products (and services) purchased on the Internet by examining electronic mail acknowledgements. When consumers purchase products over the Internet, the seller sends an acknowledgement back to the consumer listing the products purchased. Then registration entity's server makes a copy of the acknowledgment, parses it, and stores it in a database at the server. The consumer then connects to the server and downloads new purchases into a database on his PC. Client software running on the PC enables the consumer to search and analyze the list of products purchased, to check off the products received, and to load purchases into financial management software, such as Intuit's Quicken and Microsoft Money. If the seller sends an email acknowledgement of the shipment, the registration entity will get a copy of it and then inform the consumer and record the shipment in transit in the client database. If the seller does not send an email acknowledgement, but instead makes shipment information available on the seller's web site, and then the server software will probe the web site periodically, and then continue as if an email acknowledgement were sent to the consumer.

Other objects, features, and advantages of present invention will be apparent from the company drawings and from the following detailed description.

### BRIEF DESCRIPTION OF THE FIGURES

The objectives and advantages of the present invention will be understood by reading the following detailed description in conjunction with the drawing, in which:

FIG. 1 illustrates the flow of information between the consumer, the registration entity, and the electronic commerce retailer.

### DETAILED DESCRIPTION OF THE INVENTION

A method and apparatus for collecting and using post Internet sales information is disclosed. In the following description, for purposes of explanation, specific nomenclature is set forth to provide a thorough understanding of the present invention. However, it will be apparent to one skilled in the art that these specific details are not required in order to practice the present invention.

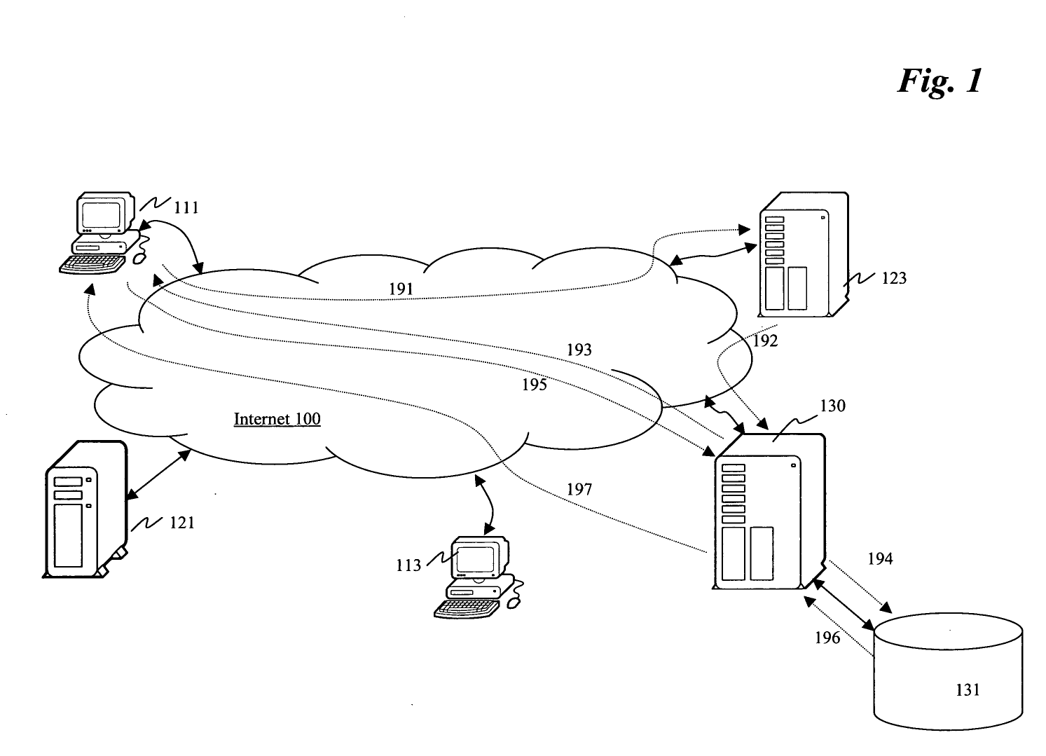

To illustrate the teachings of the present invention, FIG. 1 illustrates the data flow between a customer 111, an electronic commerce retailer site 123, and a registration entity server 130.

### Electronic Transaction Information Gathering

To track electronic transactions for the benefit of a consumer, the consumer may register with a registration entity. The registration may be performed either directly or through an agent, such as an ISP. When the consumer registers, the consumer receives an identifier (the consumer ID) from the registration entity. In one embodiment, the consumer registers at a web site provided by the registration entity.

In one embodiment, the consumer may also receive a personal email address (registered consumer email address) from the registration entity. The registered consumer email address will then be used when the consumer executes an electronic commerce transaction. In such an embodiment, the consumer provides his or her existing personal email address to the registration entity. The existing personal email address will be used to forward email messages to the consumer.

After registering with the registration entity, the consumer makes one or more purchases of items from an electronic commerce retailer. The data for such a transaction will proceed as illustrated in FIG. 1 with data flow 191. Examples of electronic commerce based retailers include Internet web site based retailers like Amazon (http://www.amazon.com/) and Buy.com (http://www.buy.com/).

When a consumer makes an electronic commerce purchase, the registration entity receives information about the transaction along data flow 192 in FIG. 1. The transaction information is also provided to the consumer 111 along data flow 193. The transaction information is usually in the form of a transaction acknowledgement from the electronic commerce retailer. Such transaction acknowledgements indicate the purchase and shipping information.

The transaction acknowledgement from the electronic commerce retailer may take the form of an email message from the electronic commerce retailer. In such cases, the transaction acknowledgement email may be passed to the registration entity in many different manners.

In a first manner, the consumer may supply the registered consumer email address received from the registration entity when making purchases. In such an arrangement, the registration entity receives the transaction acknowledgement email directly from the electronic commerce retailer since the registered consumer email address is routed directly to the registration entity. After processing the transaction acknowledgement email, the registration entity passes the transaction acknowledgement email on to the consumer's existing personal email address along data flow 193. (The consumer's personal email address was provided to the registration entity when the consumer joins the service.)

It should be noted that in this arrangement, any unsolicited commercial email (commonly known as “Spam”) that is sent to the registered consumer email address can be filtered by the registration entity. Thus, the consumer can be shielded from unsolicited commercial email (“Spam”) that results from an electronic commerce retailer that sells their mailing list (a collection of email addresses collected from a series of transactions).

In a second manner, the consumer authorizes an ISP (Internet Service Provider) to run special email parsing software. The special email parsing software checks all incoming email for transaction acknowledgements. When a transaction acknowledgement email for a registered consumer is located, the special email parsing software makes a copy of the transaction acknowledgement email and sends the copy to the registration entity.

In a third manner, the registration entity provides a special plug-in program to the email client of the consumer. The special plug-in program identifies transaction acknowledgement email messages and forwards a copy of transaction acknowledgement email messages to the registration entity.

In a fourth manner, the seller cooperatively sends the transaction acknowledgement email to the registration entity directly. Finally, in a fifth manner the consumer may send transaction acknowledgements to the registration entity. In any of these cases, both the consumer and registration entity receive a copy of the transaction acknowledgement email messages.

Transaction acknowledgement messages may be delivered to consumers in the form of World Wide Web (WWW) page. To obtain information from such transaction acknowledgements, a plug-in program may be provided for the consumer's WWW browser. The plug-in may automatically scan web pages to determine if the web page is a transaction acknowledgement. Alternatively, the consumer may invoke the web page based transaction scanner. WWW pages that appear to be transaction acknowledgements could be forwarded to the registration entity. The WWW pages may be analyzed for transaction information on the consumer's computer system such that only the transaction information is sent to the registration entity. Alternatively, the plug-in program may send the web page source such that a computer at the registration entity can extract the transaction information.

Some electronic commerce sites maintain a history of all transactions made by each consumer such that a consumer can review his past transactions. To review such information, the consumer usually navigates to the electronic commerce site and enters an authentication code (such as a username and/or password). The registration entity of the present invention can work with such system to automatically obtain new transaction information. To accomplish this, the consumer provides his authentication code to the registration entity. The registration entity then periodically examines the user's transactions to locate new transactions. The new transactions are then entered into the transaction database.

The registration entity parses the transaction acknowledgements to ascertain the type of transaction. For a purchase transaction, the registration entity's software determines what products have been purchased, how much they cost, where they were shipped, transaction reference IDs, and who were the consumer and seller, as well as other information, such as how the purchase was paid. For other known transactions, such as shipping notices, backorder notices, and return acknowledgements, the registration entity's software parses the message to obtain the appropriate data, such the reference IDs, consumer and seller information, and information about the relevant items. The registration entity's software uses a model of the seller describing the acknowledgement message content patterns and message sequencing patterns for use by the parser and to model transaction workflow. The registration entity's software stores the transaction data in a database at the registration entity server, and identifies the transaction by the consumer's registration ID.

The registration entity's software will thread together the related transactions of the consumer (e.g., purchase and shipping acknowledgements are threaded together). The registration entity thus stores (along data flow 194) all the electronic commerce transactions of the registered consumers in a transaction database 131 in an organized manner.

It should be noted that the parsing of email messages might occur at locations other than a server at the registration entity. The parsing and database functions, or parts of these functions, may occur elsewhere. For example, the consumer's own personal computer or a server at an ISP may perform the parsing or database functions. If the parsing is performed elsewhere, a mechanism is needed to update the model of the seller's messages wherever the parsing is done. Such updating can occur if necessary either periodically, when acknowledgement messages are received, by manual request (possibly because parsing software has suggested it), or by “push” distribution from the registration entity, using any Internet communication protocol such as email, FTP or Web. If the parsing was done at the consumer's personal computer, then the electronic commerce transaction information can be uploaded to a server, such as the registration entity or other server, for reliability, location independence, or to enable services provided by the registration entity or other service provider.

### Electronic Transaction Information Usage

The registration entity can provide a number of useful services to the consumers that register for the service. One simple service is purchase tracking. To keep track of all electronic commerce purchases, a registered consumer connects to the registration entity server through the Internet using a web browser or private protocol in a secure manner, as illustrated by data flow 195. The consumer authenticates himself with his registration ID. The registration entity server obtains all the transaction data from the transaction database 131 along data flow 196. The registration entity server allows the consumer to access purchase transaction data through the web at the registration entity or to download through the Internet (or an alternative network) along data flow 197 into consumer's PC, or both.

Instead of using a server at registration entity's site, the transaction database may be maintained on a server by an ISP, ECP (Electronic Commerce Provider), or other entity such as an Internet portal. Alternatively, the transaction data may be stored on the consumer's personal computer after the transaction data has been parsed (particularly if the parsing was done at the consumer's personal computer). The consumer may check off items received and query purchased items by a variety of criteria including preconfigured options and ad hoc queries. The recording of items received can occur at the consumer's personal computer or at the registration entity or other server, or both.

The registration entity can perform various mundane accounting tasks for the consumer if desired. For example, if the consumer is using a financial management software package, such as Intuit's Quicken or Microsoft Money, then the registration entity's software running on the consumer's personal computer can automatically enter electronic commerce transactions into the financial management software package. This task may be performed by a standalone application or a web browser plug-in on the consumer's personal computer. The transactions may be fetched from the registration entity's server. Alternatively, such transactions may be entered into the financial software when detected on the consumer's personal computer. Another accounting task that may be performed by the registration entity is the creation of travel and expense reports. The ability to download all or a requested subset of the consumer's purchases and related transactions from the registration entity transaction database server or other transaction database server to the consumer's personal computer exists for analysis, recovery of financial data files, or other consumer purpose. The data can be loaded into Quicken or Microsoft Money or other programs running on the consumer's PC, such as spreadsheets.

In addition, the registration entity can assist with returns to and customer service interactions with sellers. When the consumer wishes to initiate a return of one or more items to a seller, the registration entity's software running on the consumer's PC, the registration entity's or other server, or at an ISP can use the purchase transaction data to initiate a request to the seller for a return. This return request can be done via an email message to the seller, or interacting with the seller's web site, on behalf of the consumer. If a request is given to a seller, the registration entity's software will await the response from the seller. When the response is received from the seller, or for sellers who do not require a request for return, the registration entity's software records the return at the consumer's PC, or at the registration entity's or other server, creates shipping labels as necessary, arranges for shipping carrier (such as UPS or FedEx) pickup, and then notifies seller if necessary. Shipments of products from the seller to the consumer (or to third parties in the case of gifts), or returns back to the seller are tracked by the registration entity in any of these ways: (1) messages from seller notifying the consumer of pending, expected, or actual shipment or of delays or not shipping (such as out of stock) the items purchased or requested, (2) checking the seller's web site (periodically or on consumer's demand) on behalf of the consumer to look for shipment information, and (3) checking the web sites of shipping companies, such as UPS and FedEx for shipment tracking information. The status of shipments are recorded in transaction databases at the consumer's PC and/or the registration entity's or other server, or elsewhere.

The consumer's Internet-based customer service interaction with sellers can also be assisted by the registration entity's software running on the consumer's PC, the registration entity's or other server, or elsewhere. This software will help compose messages, such as providing fill-in-the-blanks templates for submission to the seller via email, electronic commerce retailer's web site, hardcopy mail, or a combination. The software will also track responses from the seller via email, seller's web site, or a combination. If a response is received in hardcopy, the consumer can log the response to the registration entity's software as well.

The transaction database 131 can be data-mined for useful consumer information. The registration entity can generate wealth of consumer demographic data by analyzing the transactions in the transaction database 131. For example, the data can be analyzed to determine the most popular electronic commerce web sites, the types of products purchased by certain demographics groups, the demographics of electronic purchasers, and other useful information. The information may be used to provide special targeted offers to the registered. One example of special offers would be digital coupons. Such an application is specified in the provisional patent application 60/115.242 filed Jan. 7, 1999 entitled “Method And Arrangement For Issuance And Management Of Digital Coupons And Sales Offers” filed concurrently with this non-provisional patent application and hereby incorporated by reference.

The transaction database 131 can be data-mined for useful electronic commerce retailer performance information. For example, the registration entity can keep track of transaction completions and delivery notices to determine which electronic commerce retailers provide the fastest service. Furthermore, the registration entity can track consumer returns to determine the electronic commerce sites that receive the least and most returns.

Wherever we have specified the consumer's PC, we include Macintoshes, workstations such as UNIX or LINUX, or any computer or other device running email or web browsing software, such as WebTV or Palm Pilot.

The foregoing has described a method and apparatus for collecting and using post Internet sales information. It is contemplated that changes and modifications may be made by one of ordinary skill in the art, to the materials and arrangements of elements of the present invention without departing from the scope of the invention.

What is claimed is:

1. A method of analyzing the content of email messages of registered users of an electronic commerce website and presenting said users with at least one offer relevant to said analyzed content, said method comprising:
(a) accepting registrations from a plurality of electronic commerce users;
(b) allocating a registration email address to each of said registered electronic commerce users;
(c) receiving at a server email messages pertaining said registration email addresses of said registered users, said server configured to receive said email messages for said registration email addresses;
(d) loading said email messages into a structured storage system;
(e) analyzing the content of one or more of said email messages pertaining to at least one of said registered users to determine one or more relevant offers to present to said at least one of said registered users; and
(f) presenting to said at least one of said registered users at least one offer relevant to the content of at least one of said email messages pertaining to at least one of said registered users.

2. The method as set forth in claim 1, wherein said offer is a digital coupon, a sale offer or an advertisement.
